(19) United States
(12) Patent Application Publication
(10) Pub. No.: US 2024/0397988 A1
(43) Pub. Date: Dec. 5, 2024

(54) CARRIERS FOR DELIVERY OF FLAVORS AND OTHER INGREDIENTS DURING BEVERAGE AND FOOD PRODUCTION

(71) Applicants: B&D Nutritional Ingredients, Inc., Carlsbad, CA (US); Proximity Malt, Milwaukee, WI (US); Premier Product Formulation, Inc., Hillside, NJ (US)

(72) Inventors: Steve J. Furcich, Milwaukee, WI (US); William W. Van Dyke, Carlsbad, CA (US); Dale E. West, Milwaukee, WI (US); Richard Neal Fischler, Hillside, NJ (US); Paula Kapel, Hillside, NJ (US)

(73) Assignees: B&D Nutritional Ingredients, Inc., Carlsbad, CA (US); Proximity Malt, Milwaukee, WI (US); Premier Product Formulation, Inc., Hillside, NJ (US)

(21) Appl. No.: 18/678,334

(22) Filed: May 30, 2024

Related U.S. Application Data
(60) Provisional application No. 63/469,662, filed on May 30, 2023.

(51) Int. Cl. A23L 27/00; A23L 2/56; C12C 5/02; C12G 3/06

(52) U.S. Cl. CPC A23L 27/88; A23L 2/56; C12C 5/026; C12G 3/06

(57) ABSTRACT

A flavor delivery vehicle described herein provides natural flavor to the food and beverage market. The flavor delivery vehicle preferably uses malted grain that has been plated with natural flavors or other ingredients to bring shelf-stable, consistently dosed and easy-to-use flavors to the food and beverage industry.

This application claims priority to U.S. Provisional Patent Application Ser. No. 63/469,662, entitled “Method for the Preparation and Packaging of Flavored Malt Extracts for Beverage Production Use,” filed May 30, 2023, the entire contents of which are hereby incorporated by reference.

### TECHNICAL FIELD

The present disclosure relates generally to a product and process for the delivery of flavors and associated aromas and other ingredients to beverages (e.g. beer, hard seltzers, coolers, kombuchas, and non-alcoholic beverages) and food products by way of a unique powdered carrier.

### BACKGROUND OF THE INVENTION

Today, flavored beverages such as beer, hard seltzers, coolers, kombuchas and the like are traditionally flavored using commercially available preparations which may be in the form of concentrates (such as fruit puree, et cetera), fruit flakes, fruit rinds, hop oils, or other liquid flavors in high purity, highly concentrated forms which, in practice, are not easy to work with. Many times these current flavor options subject the breweries to significant yield losses. The current disclosure describes an alternative system and its uses for the introduction of flavors into beverages, foods or other liquid preparations using a powdered carrier or powdered base. In addition, the current system can also be used for the introduction of flavors to non-liquid food products. The current system solves many of the problems associated with the use of flavor purees and other high purity flavor compounds in their native forms. Some of these problems may include, but are not limited to, residues and solids of the fruit preparations that must be removed and disposed of after having been present with the beverage to be flavored, economic loss of good beverage product if a decanting process is used to separate the residual fruit puree from the beverage, complexities to accurately dose small amounts and sometimes numerous flavor systems of highly concentrated forms into a large bulk tank containing the beverage to be flavored, et cetera. Furthermore, the product and process described herein reduce the risk of injury by eliminating the need to manually handle large containers, bags, totes, and other pack sizes that are used in traditional flavoring systems.

### SUMMARY OF THE INVENTION

The present disclosure relates to a flavor delivery vehicle and a process that produces a flavored, powdered carrier—such as a malt or grain base ingredient—contained within a delivery device that provides delivery of one or more flavors for production of food products and beverages. Aspects of several embodiments of the products and processes disclosed herein include continuous delivery of flavors in liquid form to a powder malt or grain base, dosing of flavors to the powder malt or grain base at specific concentration to achieve a consistent addition rate and packaging of a flavored powdered carrier such as flavored powder malt or grain base into sachets or other delivery devices for precise introduction of flavors to food products and beverages.

As described herein, examples of a flavor delivery vehicle provide natural flavor to the food and beverage market. The flavor delivery vehicle preferably uses a heat-treated milled wheat malt that has been plated with natural flavors, to bring shelf-stable, consistently dosed and easy-to-use flavors to the food and beverage industry. Using malted grains as the medium to deliver flavor allows the solubility of the medium to disappear with little residual cleanup needed, and as the medium dissolves, the flavor is left behind. The flavor delivery vehicle or powdered carrier will be shelf stable, which will provide food and beverage makers with an option that is easier to use and store than other flavor options (for example, purees, concentrates and extracts). The plating method uses natural flavors, and provides a clean label, naturally produced product for the market.

Flavors applicable to the disclosed process and product include a broad spectrum of flavor concentrates (e.g.: fruit purees, concentrated juices and extracts) as well as other high purity flavor compounds or masking agents in liquid extract form. The final product from this process is a dried malt, wheat, barley, oat, or rice powder that has been infused with flavor. The use of malt as a carrier provides a unique and dried form of flavor that is easily reproduced in correct proportions to the beverage and/or food product of choice. The process described herein produces a final product having a unique composition that can be then packaged in a convenient form that allows for flavor delivery without the need to add additional non-malt flavor ingredients (e.g.: fruit concentrates, fruit purees, other types of flavored ingredients).

Malt is produced thru the controlled germination of grain, which converts starch and proteins contained in the endosperm, into simple, fermentable sugars and soluble nitrogenous compounds. FIG. 1 shows a simplified diagram of the major steps of malt production, which is one preferred example of base material used in accordance with preferred embodiments described herein. This process is essential to the production of a fermentable substrate. Once the germination process has been completed, the converted grains are kiln dried to remove moisture. The dried malt is hygroscopic at this stage. Germination is a biological process that results in the physical degradation of the endosperm. Kilning is a thermal process that dries out the grain leaving numerous microscopic fissures and openings, while imparting many of flavor and color attributes that are essential to malt-based products. Afterwards the malt is ground to a granular powder. Husk material, if present, may or may not be removed by air and/or screen separation. The use of dehulled grains or hull-less grains would in most cases be preferred.

These germination and kilning process steps result in a granular powder that at a microscopic level are filled with fissures and other discontinuities. In addition to the discontinuities, the dried powder, because of it being hygroscopic, can rapidly absorb flavors when in the liquid state. The process described herein provides an effective product and method for delivery of flavor preparations or other liquid ingredients.

The granular flavored powder carrier described herein utilizes a unique delivery device which provides the delivery of flavored malt or grain to the beverage while minimizing the introduction of insoluble material such as insoluble fiber and various other components found in a fruit puree. In preferred embodiments disclosed herein, a dehulled grain or hull-less grain is used to further reduce the introduction of insoluble materials to the beverage. Insoluble materials can, for example, cause additional problems for the production of a beverage such as additional solids which must be filtered out or decanted from the tank containing the beverage, introduction of microbial contaminants often co-residing on the surfaces of natural products, introduction of other natural compounds (often associated with fiber fractions in products of nature such as polyphenols) that could impart undesirable effects to the beverage such as cloudiness, organoleptic instability such as off-flavors, shorter shelf life, et cetera. The use of this unique delivery vehicle also has the benefit of providing a “cleaner label or ingredient list” by showing fewer ingredients in malt-based beverages, et cetera. When, for example, the beverage is produced using examples of the powdered carrier, there is no need to additionally list the malt for the carrier on the ingredient if it was brewed or made with one of the same raw materials used for making this powder ingredient; e.g. the powdered carrier is made with malt and added to a malt beverage such as beer. By comparison, when traditional flavor carriers such as modified starches, gums, et cetera, are used, those carriers would have to appear on the ingredient list or label. “Cleaner labels” and shorter ingredient lists are a well-known consumer preference.

Taken together, the composition of the powdered carrier described herein coupled with the delivery vehicle, provides a unique and effective means for precise flavor administration. In further preferred embodiments, the powdered carrier may be presented to the beverage to be flavored in a delivery vehicle such as a porous bag or container, thereby eliminating any occupational exposure hazards often associated with handling dried powders. These hazards might include, but are not limited to inhalation of airborne dusts, explosion hazards associated with airborne dusts or dust build-ups in manufacturing areas that create GMP concerns, et cetera.

Other systems, methods, features, and advantages of the present disclosure will be or become apparent to one with skill in the art upon examination of the following detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of steps of malt production, in accordance with preferred embodiments described herein.

FIG. 2 is a diagram of a preferred example for using embodiments of the powdered carrier (e.g., “Flava-malt”) in a system for preparing flavored beverages for distribution.

### DETAILED DESCRIPTION OF THE INVENTION

The present disclosure relates to a process for the preparation and packaging of a powdered carrier in order to provide a delivery form of flavor that is more consistent, more convenient and safer to use under commercial production operations for foods and beverages.

The process described herein produces a powdered carrier which is a highly concentrated flavored powdered ingredient that when added to a food product or beverage during production, delivers the flavoring required by the food or beverage formula. The packaging of the flavored powdered carrier in sachets or other permeable containments enables the delivery of flavor to beverages and foods without the concern for additional small particles negatively impacting the final downstream filtration of the beverage. Small particles can sometimes cause filtration systems to become “blinded over” whereby the small open inherent in filters become blocked leading to reduced transfer rates (e.g.: discharge rate from the tank and through a filter) or possibly more frequent shut-downs to clean the filter.

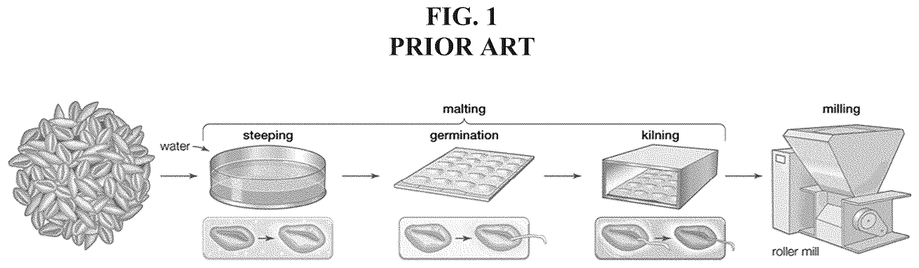

To produce the base material according to preferred embodiments described herein, grains (e.g. barley, wheat, oat) initially undergo the standard malting process whereby water is added to the grain to initiate a controlled germination, as shown in FIG. 1. This germination process results in the conversion of grain starch into simpler, fermentable sugars and soluble nitrogenous compounds. The grain may also be enzymatically treated as part of the malting process. Following this conversion, the water from the converted grain is removed and the produced malt is dried in order to stabilize the fermentable substrate, while imparting many of the desirable flavor and color attributes that are essential to malt based products. This malt then undergoes milling to reduce the particle size of the malt.

In preferred embodiments, the grains subjected to the malting process may lack a husk, such as wheat and hull-less barley, other hull-less grains, or grains that have had the husk substantially removed either before or after malting.

Milled malt may contain less than 8% w/w moisture and is hygroscopic. In addition, and during the drying process, microscopic fissures develop in the malted and milled grain. The reduction in particle size of the hygroscopic malt coupled with the presence of microscopic fissures, provides an ideal structure with maximal surface area and internal carrying volume for the plating of flavors to the converted grain.

The plating of flavors onto the powdered, granular base ingredient after the malting process is accomplished by applying the flavor composition in a liquid form, onto the milled, powdered malt or grain as a fine spray or by other suitable adsorptive process. In some embodiments the flavor composition is physically mixed with the powdered, granular base using a ribbon blender. While the ideal solvent for the flavor and/or other ingredient(s) encompassed by preferred embodiments of the process is water, other solvents such as ethanol or a suitable lipid could be used. The concentration of flavor in the liquid composition used for plating onto the base will vary according to the flavor type and is preferably between 3 and 20% in the chosen solvent.

In some preferred embodiments, before adding the flavor to the malted grain, the grain may be screened using appropriate screening equipment (e.g.: SWECO MX30S66CBLKSDXB 0.5 HP) if it is lumpy, then added to the ribbon blender. Preferred examples of the malt include Milled Mid Atlantic Wheat Malt. The flavor is added slowly while mixing. After all flavor is added, the blender is sealed and the grain is mixed for about 10 minutes at 1600 RPM. The material is then discharged through a shifter (e.g.: SWECO screen #10 Mesh) into containers for use.

Flavors that are appropriate for the process described herein are essentially limitless. The flavor may be provided to the flavor composition in the form of a concentrate or a fruit puree. Examples of flavored, powdered carriers in the form of flavored malts (“Flava-malt”) that have been produced are shown in Table 1 below.

TABLE 1
Description

Natural Apple Type Flava-malt
Natural Chocolate Type Flava-malt
Natural Lemon WONF Flava-malt
Natural Mango Type Flava-malt
Natural Orange WONF Flava-malt
Natural Pineapple Type Flava-malt
Natural Raspberry Type Flava-malt
Natural Raspberry Type Flava-malt
Natural Peach Type Flava-malt
Natural Toffee Type Flava-malt
Natural Sauvignon Blanc Type Flava-malt
Natural Passion Fruit Type Flava-malt
Natural Coconut Type Flava-malt
Natural Vanilla Flava-malt
Natural Vanilla Cream Flava-malt
Natural Vanilla Bean Flava-malt
Natural Cherry Flava-malt
Natural Black Cherry Flava-malt
Natural Lime Flava-malt
Natural Strawberry Flava-malt
Natural Blueberry Flava-malt
Natural Pumpkin Flava-malt
Natural Cranberry Flava-malt
Natural Grapefruit Flava-malt

In addition, flavors also include but are not limited to the following: hop flavors, smoke flavors, coffee flavors, nut flavors, chili or spice flavors, herbal flavors such as basil or lemongrass, other natural or synthetic flavors, essential oils, preservatives (e.g.: rosemary extracts, carnosic acid, ascorbic acid, tocopherols, hop acids, et cetera) stevia, rare sugars (e.g.: allulose, et cetera), sweeteners containing and higher molecular mass sugars, flavor masking agents, cannabinoids, ingredients having claimed health or sports performance benefits (e.g.: dietary or food supplement ingredients, et cetera), and flavor modifiers and/or flavor preparations used for mimicking alcohol in non-alcoholic and/or reduced alcohol beverages, among others. Additional flavors and certain functional ingredients for inclusion are further described in the Claims. Importantly, the current process of plating a powdered base carrier such as malt does not restrict the plating of flavors and non-flavors not explicitly noted.

Following the plating of flavors onto the malt, the moisture levels are adjusted for stability.

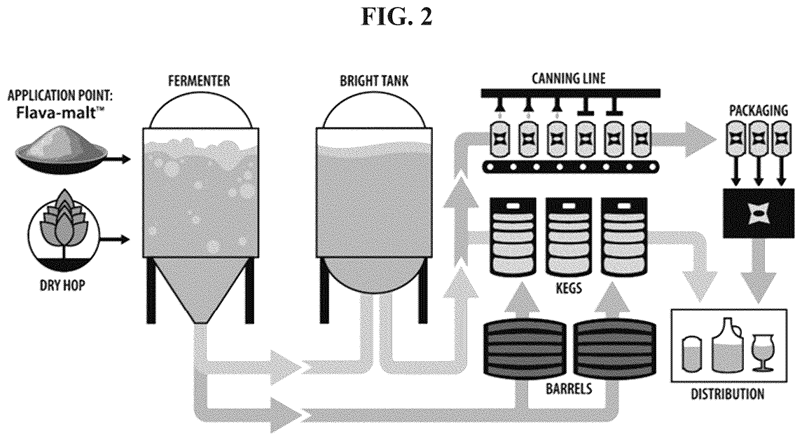

In preferred embodiments, the flavored powdered carrier disclosed herein is packaged within a delivery vehicle. The flavored powdered carrier is preferably packed into permeable sachets or other delivery devices appropriate for flavor delivery. In addition to sachets, packaging could also include but is not limited to “large tea bag type sachets,” filter socks and metal baskets with appropriately sized screens. Importantly, the present process allows for the dissolution or diffusion of the flavored powdered carrier, such as flavored malt, into the beverage without the introduction of excess insoluble material. As such, the present process allows for a safer, simpler and likely more precise form of flavor delivery since the sachets or packages containing the flavored powdered carrier would be pre-measured doses. The present process is thus suited for small as well as large scale commercial/industrial beverage production operations. It presents clear advantages for reducing the time, labor expense and potential errors associated with manually weighing and dosing individual ingredients. For example, usage rates can be easily determined for each individual batch using a simple lb per barrel dosage. In preferred embodiments, the flavored powder carrier is added in an amount of 0.1 to 1 lb per barrel. In further preferred embodiments, the flavored powder carrier is added in an amount of 0.125 to 0.25 lb per barrel. In some embodiments, the delivery vehicle is attached to a rope or tubing that allows it to be suspended in a tank, such as a fermenter tank, lager tank, bright tank or other tank used in the production of a product to be flavored. FIG. 2 shows a diagram of a system for preparing flavored beverages for distribution, where embodiments of the powdered carrier described herein (e.g., “Flava-malt”) are added to a fermenter along with dry hop.

In further preferred embodiments, delivery devices may include a reusable screened polymer or metal basket, with or without a filter sock, containing the flavored powdered carrier and other liquid ingredients that allows the diffusion of the flavor to the liquid product it has been immersed in.

In additional preferred embodiments, the flavored base ingredient or flavored powdered carrier is combined with further ingredients within the delivery device, such as carrageenan, Irish moss, gelatins of various origins, adsorbents such as bentonite and other clays, silica gels, and/or proteolytic enzymes such papain, preservatives (e.g.: organic acids and lipids, et cetera), to prevent potential sources of clouding and/or organoleptic instability caused by but not limited to proteins, polyphenols and/or protein polyphenol complexes. Further preferred embodiments may also include foam stabilizing or enhancing ingredients including but not limited to gum arabic, other polysaccharides, et cetera, that improve the stability of foam.

In further preferred embodiments, the flavored powdered carrier may also include one or more of an alcohol, a glycol, a glycerin, a sugar or a glyceride.

In additional preferred embodiments, the delivery vehicle or containment device may be sterilized for use. The sterile container has little or no residual microbial contamination, such as a lined or unlined disposable bag, with or without a resealing mechanism, that allows the flavored powdered carrier and other ingredients to remain sterile during storage and handling, and allows the sterile package to be opened immediately at time of usage to minimize potential introduction of microbial contamination to the product to be flavored.

The powdered carrier produced according to the present disclosure may be used in any beverage but is particularly useful in malt-based beverages such as beer, maltas, hard seltzers, coolers and the like. Additionally, the product produced can be added to any food product where a consistent flavor addition is required and appropriate. Incorporating this powdered carrier directly into a formulated food or beverage offers several advantages compared to adding a flavor separately. Most notably is the ability to consistently deliver one or more flavors and/or other ingredients to the food or beverage. In certain cases this powdered carrier can provide enhanced or more pronounced aromas not otherwise possible using only traditional flavor ingredients, e.g. native fruits, fruit purees, et cetera.

The present disclosure also provides for the use of the flavored powder carriers to add flavor to food products or semi-finished food products, such as nutrition bars, confectionary products, cereals, bakery goods, dairy products, ice cream, dairy analogs (e.g. yogurts, et cetera), powdered drink mixes, and snack foods.

The flavor carrier preparations described herein provide and release a higher level of the flavor's aroma to a finished beverage or food product than when using the native form of the flavor, such as fruit, or a concentrate thereof, such as a fruit puree. In addition, the finished beverage or food product is not required to list the name of the malt or grain-based carrier in its list of ingredients, ingredient panel, or other ingredient declaration.

The terms below, as used in the specification and examples, have the meanings provided.

Beer Barrel: BBL, defined in this instance as 31 US liquid gallons

Brewhouse: Collectively, the vessels used to convert malt, grains and water into wort, and can include a cereal cooker, mash tun, lauter tun, brew kettle, whirlpool and/or hopback.

Bright Tank: A vessel in the brewery that matures, clarifies and carbonates beer after fermentation. In some breweries, it can act as a serving tank.

Brink: A vessel used in the brewery to mix solids, liquids or purees into the wort or beer.

Crash Cooling: In a brewing environment, when the beer is fully fermented and ready to be packaged, the process involves lowering the temperature of the beer very quickly to near freezing temperatures and holding it there for 24 hours.

Diacetyl Test (forced): In a brewing environment, it is a quick test that can be run in the brewery to confirm that a beer has completed fermentation and thus can be packaged with less risk of developing off-flavors due to processes within the brewery. Used as a check to confirm beer is ready for packaging.

Fermentation tank: The vessel in a brewery where wort is stored, yeast is introduced and the process of fermentation takes place.

Fining/Fining agent: Substances used to help clarify beer by removing unwanted particles suspended in liquid.

Flavor Extracts: Culinary liquids using fruit or other flavors that have been reduced into an ethanol or polypropylene glycol solution

Fruit Concentrates: Fruit juices that have excess water removed

Fruit Purees: Cooked fruits that has been made into a soft, creamy paste, may or may not be shelf stable

Haze: A parameter in beer sensory evaluation caused by suspended insoluble particles of colloidal or larger size that can be perceived visually.

Heat Treated: In this instance, product undergoes treatment for a set time frame at a set temperature to denature possible food pathogens.

Malted grains: Mainly cereal grains that have undergone the malting process of cleaning, steeping, germinating and kilning

Milled malt: In the examples, malted grains that have been run through a four-roller mill to expose more surface area of the starch

Mouthfeel: The physical sensations in the mouth produced by a particular product, considered as a key parameter in beer sensory evaluation.

Natural Flavors: Flavors that derive their aroma or flavor chemicals from plant or animal sources

Packaging: Packaging is how beer is processed to be sold, and will include kegs or barrels (draft) or glass bottles or aluminum cans

Plated flavors: Flavor ingredients, in liquid and/or powder form, that are applied evenly on the surface of a carrier, which in preferred embodiments herein is a pasteurized milled wheat malt

Residual sugars: Sugars that are still present in beer after fermentation and will contribute to mouthfeel and other sensory parameters.

Shelf-stable products: Products that can be stored at room temperature for a stated period of time

Terminal Gravity: in a brewing environment, the measurement taken after the yeast is finished consuming fermentable sugars, leaving behind non-fermentable sugars, proteins and peptides.

Wheat malt: Cereal grain of the genus Triticum

Wort: The liquid extracted from the mashing process during the brewing of beer or whiskey. Wort contains the sugars that will be fermented into alcohol.

The following examples provide additional discussion of preferred embodiments and are not intended to limit the scope of the disclosure.

### Example 1—Raspberry Milk Stout

⅛^{th} lb. per beer barrel (BBL) of an exemplary flavor carrier described herein, which was prepared using a raspberry flavor, was used in this example. The raspberry flavor, in the form of raspberry essential oils, was mixed with a powdered malted grain in a ribbon blender to prepare the raspberry flavor carrier, which contained about 6-9% raspberry flavor per weight of the total flavor carrier. The resulting raspberry flavor carrier was loaded into a sachet. The raspberry flavor carrier was substituted for fruit puree for a total of 8 bbls. After terminal gravity had been reached (yeast activity was over), the brewer waited two days before crash cooling and then ran a forced diacetyl test to ensure no off-flavors in the beer at that stage. The flavor carrier was added to the bright tank. No problems with transferring or clumping were observed. It was then conditioned in the bright tank for one week before packaging into kegs. They noted that it exceeded flavor standards—the flavor was more raspberry jam/cooked raspberry than fresh fruit raspberry, but flavor was acceptable. The aroma was good, cooked raspberry, and very bright, with little haze or mouthfeel added.

### Example 2—Lemon Pineapple Sour Ale

1 lb of powdered flavor carrier was used in total in this example—½ lb lemon flavored malt and ½ lb pineapple flavored malt in a 4 BBL sour beer recipe with rotating flavors, typically fruit purees or flavor extracts. The lemon flavored malt carrier was prepared by mixing lemon essential oils with a powdered malted grain in a ribbon blender to obtain a pineapple flavored malt carrier having 8.7% lemon flavor per weight of the total flavor carrier. The pineapple flavored malt carrier was prepared by mixing pineapple essential oils with a powdered malted grain in a ribbon blender to obtain a pineapple flavored malt carrier having 8.7% pineapple flavor per weight of the total flavor carrier. The flavored malts were loaded into two different sachets. The flavor carrier was added after the beer had reached terminal gravity (most of the yeast activity was over) and added to the bright tank when the beer was cooled. The beer sat in the bright tank for about 7 days before transferring to packaging-beer was packaged in draft kegs and sold in their brewpub. No problems were noted with additional haze, and flavor and aroma were noted as better than extract, which can have a medicinal flavor. The pineapple flavor was stronger than the lemon.

### Example 3—IPA

⅛^{th} lb. per bbl. of an exemplary mango flavor carrier was used in this example. The mango flavored malt carrier was prepared by mixing mango essential oils with a powdered malted grain in a ribbon blender to obtain a mango flavored malt carrier having 12% mango flavor per weight of the total flavor carrier. The mango flavor carrier was loaded into a sachet and was used for a total of 4 BBLs. The flavor carrier was added to see whether it could enhance some of the tropical IPA flavors normally expressed by the hops, and was not used as a substitute for any other flavor. After brewing, four barrels were segregated from the batch, and sent to a smaller bright tank. The flavor carrier was added via brink equipment, the beer was agitated using CO2, and left for two days to mature. After two days it was packaged into kegs and cans. No fining, or pasteurization was used. Nothing was noticed that was out of the ordinary with transferring and no clumping was observed. The brewers noted that all of the flavor was noticeable the next day in the bright tank, being hoppy, definitely getting more mango on the nose (aroma) in their flagship IPA. Sensory came back very positive, the brewer liked the flavor, and would try again for a taproom beer.

### Example 4—Raspberry Sour

1/10^{th} lb. per bbl. of an exemplary raspberry flavor carrier was used in this example. The raspberry flavor, in the form of raspberry essential oils, was mixed with a powdered malted grain in a ribbon blender to prepare the raspberry flavor carrier, which contained about 6-9% raspberry flavor per weight of the total flavor carrier. The resulting raspberry flavor carrier was loaded into a sachet and was used for a total of 20 bbls. The flavor carrier was used at a lower rate, and the brewer reduced his puree additions by 50%. The flavored malt was added during dry hopping to the bright tank and the brewer did not have the ability to cold crash. No problems with transferring or clumping were observed. It spent two days conditioning before being packaged into cans. The brewer noted that it met their flavor expectations and had a better aroma.

What is claimed is:

1. A flavored carrier preparation for use in flavoring foods and beverages, comprising:
a flavored, powdered grain material, wherein the flavored, powdered grain material comprises a powdered, malted grain material and a flavor composition plated onto outside surfaces of the powdered, malted grain material; and
a porous delivery vehicle, wherein the flavored, powdered grain material is contained within the porous delivery vehicle and wherein the porous delivery vehicle is configured to be immersed into a food or beverage to deliver flavor during preparation of the food or beverage.

2. The flavored carrier preparation of claim 1, wherein the powdered, malted grain material comprises hull-less or husk-less grain that has been subjected to a malting process.

3. The flavored carrier preparation of claim 1, wherein the flavor composition comprises one or more flavoring agents, sweeteners, extracts, essential oils, dietary supplements, food supplements, or flavor modifiers.

4. The flavored carrier preparation of claim 3, wherein the flavor composition further comprises a solvent.

5. The flavored carrier preparation of claim 1, further comprising one or more functional ingredients, wherein the functional ingredients comprise one or more clarifying agents, fining agents, adsorbents, proteolytic enzymes, preservatives, or stabilizers, and wherein the functional ingredients are contained within the porous delivery vehicle.

6. The flavored carrier preparation of claim 1, wherein the porous delivery vehicle is a sachet, a screened polymer, or a metal basket.

7. A method for preparing a flavored carrier preparation for use in flavoring foods and beverages, comprising:
subjecting grains to a malting process to produce malted grains;
drying and milling the malted grains to produce a powdered, malted grain material;
plating a flavor composition onto outside surfaces of the powdered, malted grain material to produce a flavored, powdered grain material; and
loading the flavored, powdered grain material into a porous delivery vehicle, wherein the porous delivery vehicle is configured to be immersed into a food or beverage to deliver flavor during preparation of the food or beverage.

8. The method of claim 7, wherein the grains are hull-less or husk-less grains.

9. The method of claim 7, wherein the flavor composition comprises one or more flavoring agents, sweeteners, extracts, essential oils, dietary supplements, food supplements, or flavor modifiers.

10. The method of claim 9, wherein the flavor composition further comprises a solvent.

11. The method of claim 7, further comprising the step of loading one or more functional ingredients into the porous delivery vehicle, wherein the functional ingredients comprise one or more clarifying agents, fining agents, adsorbents, proteolytic enzymes, preservatives, or stabilizers.

12. The method of claim 7, further comprising the step of sterilizing the porous delivery vehicle before or after loading the flavored, powdered grain material into the porous delivery vehicle.

13. The method of claim 7, wherein the porous delivery vehicle is a sachet, a screened polymer, or a metal basket.
